(19) United States
(12) Patent Application Publication
(10) Pub. No.: US 2012/0194521 A1
(43) Pub. Date: Aug. 2, 2012

(54) SYSTEM AND METHOD FOR MORE EFFICIENT IMAGE PROCESSING

(76) Inventors: Yaron Ostrovsky-Berman, Petach Tikva (IL); Yoel Drori, Kfar Saba (IL); Guy Engelhard, Kiryat Ono (IL); Tiferet Gazit, Tel Aviv (IL)

(21) Appl. No.: 13/019,102

(22) Filed: Feb. 1, 2011

(51) Int. Cl. G06T 11/20

(52) U.S. Cl. 345/440

(57) ABSTRACT

A system and method for graph traversing algorithms which computes at least a portion of the local costs in advance and then stores the computed local costs for later use.

### FIELD OF THE INVENTION

The present invention is of a system and method for more efficient image processing, and in particular but not exclusively, to such a system and method that is useful for image processing supported by graph traversing algorithms.

### BACKGROUND OF THE INVENTION

Many different types of image processing methods incorporate graph traversing algorithms and/or otherwise use graphs as part of the method, including but not limited to, the fast marching algorithm, A*, Dijkstra's algorithm and so forth. For these algorithms, typically the calculation of a local cost (i.e. —the cost at a node, as for algorithms such as the fast marching algorithm, or the cost at an edge, as for algorithms such as Dijkstra's algorithm) forms a significant part of the overall computational burden. The local cost is also referred to as the speed function. However, even when the graph structure (i.e. —structure of nodes and edges, but not their costs) is known in advance, as for example for image processing, in which the image may be represented by a grid of voxels, many of the above algorithms traverse only a small part of it, and the local cost is needed only for the portion that is actually traversed, which means that pre computing all possible local costs in the graph is potentially inefficient in terms of memory consumption and consumption of other computing resources. Thus, these algorithms typically calculate the local cost sequentially as the graph structure is traversed at the moment that such a cost is required.

These properties increase the difficulty of efficiently using a plurality of computer resources in the implementation of these algorithms, such as for example through a modern multi-core computing architecture. For example, typically only the time independent part of the total cost may be computed in advance (i.e. —the portion that is independent of other properties and/or conditions related to other elements of the graph, such as cumulative or path costs). As used herein, the term “local cost” refers to the time-independent part of the cost of an element. If additional time-dependent costs are added to the calculation of the path cost, in addition to this local cost at the current element and previously-computed path costs at its neighbors, the time-dependent costs are computed as they are needed, and are not computed in advance or in parallel.

Dijkstra's algorithm and other graph traversing algorithms are described in Cormen, Leiserson and Rivest, “Introduction to Algorithms”, McGraw-Hill.

A* is described in N. Nilsson, “Problem-Solving Methods in Artificial Intelligence”, McGraw-Hill, N.Y., 1971. Fast-marching methods are described in J. A. Sethian, “A fast marching level set method for monotonically advancing fronts”, Nat. Acad. Sci. 93(4) (1996) 1591-1595; and in Sethian, “Fast marching methods”, SIAM Rev. 41 (2) (1999) 199-235; and in http://math.berkeley.edu/.about.sethian, and in a book by Sethian “Level-sets method and Fast Marching Methods: Evolving Interfaces in Computational Geometry, Fluid Mechanics, Computer Vision and Material Sciences”, Cambridge University Press, 1999. Other graph traversing algorithms are described in U.S. Pat. Nos. 6,324,478; 6,604,005 and 6,496,188.

A* and Fast-Marching are compared in P. Melchior et al. “Consideration of obstacle danger level in path planning using A* and Fast-Marching optimization: comparative study”, Signal Processing, v.83 n.11 p. 2387-2396, November 2003; and in Livingstone et al. “Fast marching and fast driving: combining off-line search and reactive A. I.”, 4th International Conference on Intelligent Games and Simulation (GAME-ON 2003), November 2003, UK. The paper by Melchior relates to a mobile robot application. The paper by Livingstone relates to a video game.

A* usually solves continuous path problems by converting the problem to a discrete problem defined by a graph and then finding a solution on the graph. Fast-Marching solves moving interface type problems in a continuous space by using grid based numerical approximations to the underlying problem and more specifically by numerically solving the associated Eikonal equation.

Finding paths in 3D images using Fast Marching is described in T. Deschamps and L. D. Cohen “Fast Extraction of Minimal paths in 3D images and application to virtual endoscopy”, Medical Image Analysis, Vol. 5, Issue 4, December 2001.

Targeted marching (described in U.S. patent application Ser. No. 10/597,221, filed on Dec. 26, 2004 and owned in common with the present application, hereby incorporated by reference as if fully set forth herein) combines the fast marching algorithm with a consideration of the total expected cost to a goal.

### SUMMARY OF AT LEAST SOME ASPECTS OF THE INVENTION

The present invention, in at least some embodiments, provides a system and method which overcomes the drawbacks of the background art for graph traversing algorithms by computing at least a portion of the local costs in advance of or separately from the actual use of the local cost by the algorithm, and then storing the computed local costs. By “computing a local cost in advance” it is meant the local cost is optionally calculated even before the graph traversal process is started and/or that the local cost is calculated before the actual use thereof by the algorithm and/or that the local cost is calculated independently of the operation of the algorithm.

By “computing a local cost separately”, it is meant that at least a portion of the local costs are computed separately from performance of the graph traversing algorithm, for example, as described in greater detail below, by a different computer resource. Preferably, at least part of these separately calculated local costs are available to the graph traversing algorithm when required.

The ability to store the computed local costs in advance for later use means that the entire process of graph traversal, and hence the process of image analysis, can be performed more quickly. Furthermore, where a plurality of computational resources are available, as for example a plurality of threads and/or processors (or other resources as described herein), the calculation of the local costs may be distributed among computational resources, thus potentially using such resources more fully and decreasing the overall amount of time required for image analysis.

Although the system and method as described herein are implemented for image processing methods for the purpose of description only and without any intention of being limiting, in fact many such applications are possible, including but not limited to robotics (including without limitation robotic navigation), computer games, graphics, artificial vision, fluid mechanics and problems in wave propagation (including without limitation for seismic analysis), combustion, manufacturing of computer chips (semiconductor manufacturing), computer animation, computational geometry, noise removal, biological modeling (including without limitation tumor modeling) and modeling of chemical pathways, and the like.

By “graph traversing algorithms” it is meant any algorithm involved in finding a path or planning a path to a goal, regardless of whether an actual “graph” is employed, as well as any algorithm in which a graph is traversed even without finding or planning a path to a goal as for example for marking all the nodes that were reached before termination, or assigning a property to the nodes reached (such as a path cost). Also, the term “graph traversing algorithms” encompasses algorithms in which the traversal or other use of a graph is incidental to the process to be performed; for example and without limitation, the Fast Marching algorithm relates to tracking moving interfaces in a continuous space and more specifically to approximating a numerical solution to the Eikonal equation in that space. During the performance of this algorithm, a graph is used to achieve this solution and hence the Fast Marching algorithm is described herein as a graph traversing algorithm.

By “path cost” it is meant the cumulative cost of traversing the graph from the source to the node reached and/or the arrival time at such a node when traversing the graph beginning at a specified starting node or set of nodes.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a background art method for a graph traversing algorithm;

FIG. 2 shows an exemplary, illustrative non-limiting method for an improved graph traversing algorithm according to at least some embodiments of the present invention; and

FIG. 3 shows an exemplary, illustrative non-limiting system according to some embodiments of the present invention.

### DESCRIPTION OF THE PREFERRED EMBODIMENTS

The present invention is, in at least some embodiments, of a system and method for graph traversing algorithms, comprising computing at least a portion of the local costs in advance of actual use by the traversing part of the algorithm (as previously defined) and/or by a different computer resource, and then storing the computed local costs. The system and method are useful for such applications as image processing, for example. Non-limiting examples of graph traversing algorithms with which the present invention may optionally be implemented include the fast marching algorithm, A*, Dijkstra's algorithm, the breadth first search algorithm (BFS), the depth first search algorithm (DFS), Uniform Cost Search (UCS) and the targeted fast marching algorithm. By “local cost” it is meant a cost to be calculated at each node d of the graph, as determined by the specific graph traversing algorithm, which for example may optionally be associated with the node d itself (e.g. —the fast marching algorithm), or a combination of the cost at node d and the expected distance to the goal (e.g. —A*, the targeted marching algorithm). The local cost may optionally be independent of the path that was used to reach the node. However, if part or all of the local cost is not path independent, then preferably the non-path dependent part is calculated separately and/or in advance of its use by the graph traversing algorithm, while the path dependent part is then preferably only calculated once that node is reached. For example, optionally the non-path dependent costs are time independent costs while the path dependent costs are time dependent costs, for example for an algorithm such as the Fast Marching algorithm which relate to tracking movement of an interface. Also a similar method may be used to calculate all of the weights of the edges connecting to node d (e.g.- Dijkstra's algorithm); one of ordinary skill in the art could easily adapt the method as shown herein for this type of algorithm.

The system and method are advantageously implemented with a plurality of computational resources, in which each computational resource is capable of supporting one or more separate threads, calculations and/or processes. For example and without limitation, each computational resource may optionally comprise a separate computer, a separate thread of a multithreaded processor, a separate VM (virtual machine) or a separate hardware processor, a plurality of any of the above, or a combination thereof.

According to at least some embodiments of the present invention, the method comprises computing a plurality of local costs for a portion of the graph that is not currently being traversed; storing said plurality of local costs to form stored local costs; as each portion of the graph is traversed to form a traversed portion, retrieving a local cost associated with said traversed portion in said stored local costs for traversing said traversed portion of the graph; if said local cost associated with said traversed portion is not in said stored local costs, calculating said local cost associated with said traversed portion. By “a portion of the graph that is not currently being traversed”, it is meant a node or an edge that is expected to be traversed by the graph traversing algorithm in the future (unless of course the traversal terminates). The specific graph traversing algorithm determines which nodes (edges) are expected to be traversed in the future. For example and without limitation, for the Fast Marching algorithm, such nodes are neighbors of the currently considered nodes. For Dijkstra's algorithm, these edges lead out from the currently considered nodes. In other graph algorithms, it's possible that other nodes may be considered, e.g. neighbors of neighbors. More generally, each graph algorithm has a criterion that generates a list of nodes to be considered in the future from the currently considered nodes. Preferably, the local costs are calculated as determined by the requirements of the graph traversing algorithm being implemented, although in fact these properties of the node may be independent of the actual algorithm used. For example, optionally the local costs may optionally be marked and/or sorted according to their relative importance or urgency for calculation, so that more important or urgent local costs are calculated before other such costs. Urgency may optionally be determined according to the relative order in which a local cost will be needed and/or according to computational intensiveness of a particular local cost, with more computationally intensive local costs preferably being calculated before other such local costs. Also preferably, the processes of computing and storing the local costs are performed separately from the process of retrieving said local cost for traversing the traversed portion of the graph.

Preferably, the stored local costs are available in a storage that may be accessed by any computational resource involved in traversing the graph. For example, if the storage comprises a physical memory, then preferably the physical memory may be accessed by any computational resource involved in traversing the graph.

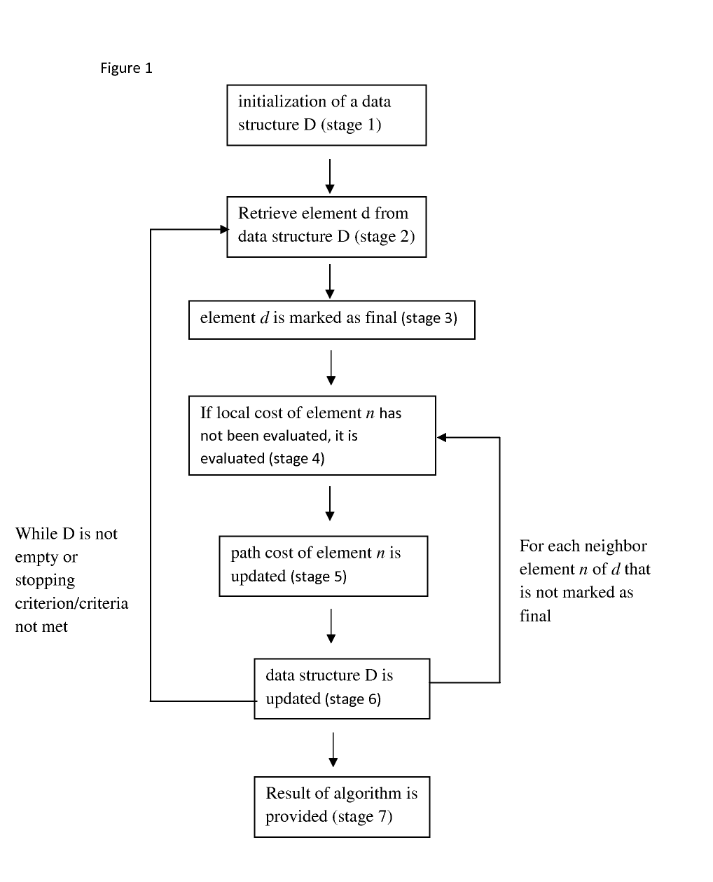

Referring now to the drawings, FIG. 1 shows a background art method for a graph traversing algorithm. The method begins with the initialization of a data structure D with an initial set of elements in stage 1.

Stages 2-6 are then performed as long as the data structure D is not empty and the stopping criterion is not false (or stopping criteria are not false). As a non-limiting example, reaching a goal may cause the stopping criterion to be true. In stage 2, the next element d is retrieved from D (according to a criterion or a plurality of criteria specified by the graph traversing algorithm). In stage 3, element d is marked as final.

For each neighbor element n of d that is not marked as final, stages 4-6 are performed. If the local cost of element n has not been evaluated, it is evaluated. In stage 5, the path cost of element n is updated from the path cost of element d (and of other neighbor elements that are marked final) and the local cost of element n. Optionally one or more other attributes of element n are also updated, according the specific graph traversing algorithm being employed. In stage 6, the data structure D is updated according to the new cost from the neighbor elements n of element d (e.g. —by using the path cost). If however, the element n is not in D, then this element must be added to the data structure D.

In stage 7, once all elements of the data structure D have been considered or a goal has been reached (or other stopping criterion is set to true), then the result of the algorithm is provided. As a non-limiting example, such a result may comprise the path cost of the last node in the data structure D, the overall path traversed and/or the set of all elements reached.

As previously described, for this exemplary background art method, local costs are computed as necessary and are also computed sequentially. For path costs, such a calculation needs to be performed sequentially as the path cost depends upon the path costs from neighboring nodes as well as the local cost of the actual node being considered. However, this restriction does not apply to local costs.

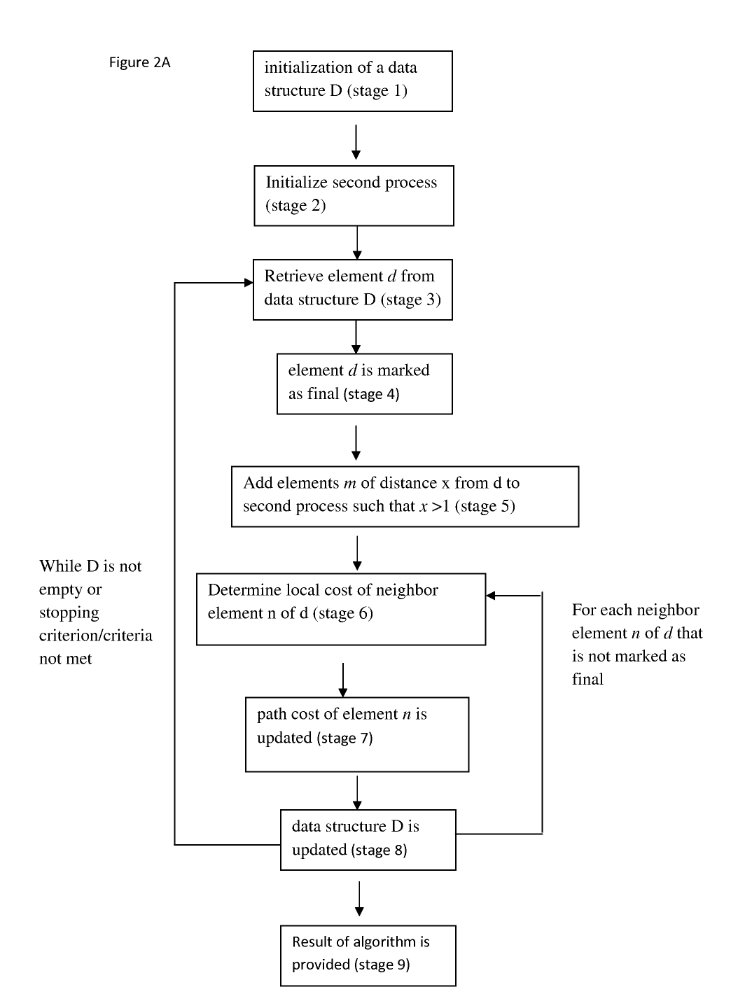

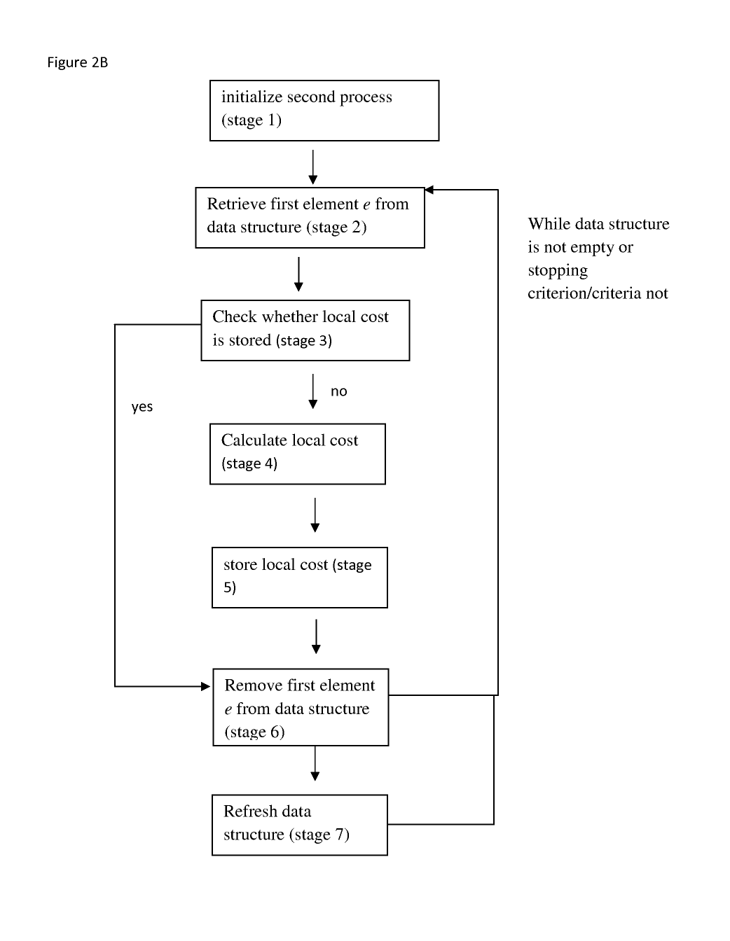

FIG. 2 shows an exemplary, illustrative non-limiting method for an improved graph traversing algorithm according to at least some embodiments of the present invention, in which at least some local costs are computed in advance and are preferably computed in parallel, while avoiding excessive memory overhead by pre-computing local costs only for elements that are likely to be required within a reasonable timeframe. The exemplary method shown assumes that a plurality of computational resources are available and that at least one computational resource calculates at least a portion of the local costs, for example optionally as a second process, while at least one other computational resource performs the graph traversing algorithm. FIG. 2A shows the first process of the exemplary, illustrative non-limiting method for an improved graph traversing algorithm according to at least some embodiments of the present invention, while FIG. 2B shows the second process for this exemplary, illustrative non-limiting method for an improved graph traversing algorithm according to at least some embodiments of the present invention.

By “first process” it is meant that the graph traversing algorithm is performed according to FIG. 2A, while the “second process” relates to the supportive calculation of local costs according to FIG. 2B. However either or both of the first and second processes may optionally be performed in the background; also each such process may optionally be a plurality of processes. The stages described in FIG. 2A are not necessarily synchronized with the stages described in FIG. 2B; instead, each process is preferably performed according to the available computational resources. Also if there is more than one instance of the second process, then the plurality of instances of the second process are not necessarily synchronized with each other. It is possible to manage the processes in any suitable manner as long as the first process (i.e. —the process performing the graph traversing algorithm) receives the resources that it requests in a timely manner. For example, optionally the operating system of the computational resources could optionally manage these processes. Alternatively or additionally, it would optionally be possible to optimize such management as could be implemented by one of ordinary skill in the art, for example according to the requirements or the most efficient operation of the graph traversing algorithm and/or according to the nature of the graph structure or any other suitable criteria.

As described herein, it is assumed that the first process and the one or more second processes, supported by a plurality of computational resources, have access to a shared physical memory, to allow all such processes to store and retrieve local costs. According to the embodiments described herein, the first process must not deallocate or reuse memory used by an element, such as a node to store the result of the local cost. It is safe to do so only after the element has been marked FINAL and has left a data structure associated with the second process(es), such as a queue for example. The first process has access to a data structure for calculations as does the second process (for each of the first process and second process, optionally a plurality of processes are implemented).

In FIG. 2A, stage 1 is performed as for FIG. 1, featuring the initialization of a data structure D with an initial set of elements. The elements for example may optionally comprise nodes and/or edges, according to the type of graph traversing algorithm being performed. The selection of the initial set of elements and hence the determination of the location within the portion of the graph to start traversal may optionally be performed according to a seed. The terms “seed”, “start node”, and “source” are used herein interchangeably. Optionally a plurality of seeds may be used to start traversal at a plurality of locations. In stage 2, the second process or processes is/are initialized as described in FIG. 2B. The methods of FIGS. 2A and 2B preferably operate in parallel.

Stages 3-8 are performed as long as the data structure D is not empty and the stopping criterion is not false (or stopping criteria are not false). As a non-limiting example, reaching a goal may cause the stopping criterion to be true. In stage 3, the next element d, whether a node or an edge, is retrieved from D (according to a criterion or a plurality of criteria specified by the graph traversing algorithm, for example according to the element d with minimal path cost). In stage 4, element d is marked as final.

In stage 5, a function operating according to a criterion (or criteria) is used to generate a list of elements that are added to the data structure. As a non-limiting example, the list of elements comprises at least the neighbors of element d but preferably comprises also at least one additional set of “neighbors of neighbors” of element d, which may be referred to as “distance 2 neighbors” and may indeed optionally comprise any depth of neighbors with regard to element d (i.e. —“distance x neighbors”, in which x is any integer greater than zero). The number and/or identity of neighbor elements m to be added may optionally be predetermined or alternatively may optionally be determined “on the fly”, for example according to the extent to which the graph has been traversed, the calculated distance to a goal, and so forth. However for this stage, preferably x=2 although optionally x is any integer greater than one.

In this exemplary method, the selected neighboring elements m of element d are optionally and preferably added to the data structure of the second process (or of one of the second processes) described in FIG. 2B. As described herein, the data structure may optionally be shared by a plurality of processes. Alternatively or additionally, elements may optionally be added to the second process described in FIG. 2B even if they are not neighbor elements m of element d.

Optionally, elements are added to the second process for calculating local costs according to one or more criterion selected from the group consisting of urgency or whether an element has at least a threshold probability to be required for said traversing. Regarding threshold probability of being required, an element may have at least such a probability of being required for graph traversal for example to locate a specific feature within an image, for example according to degree of intensity of voxels and/or physical location.

For each neighboring element n of d that is not marked as final, for example preferably at least “distance 1 neighbors” and the like as previously described (such that preferably x=1), stages 6-8 are performed. The local cost for each element n is determined in stage 6. Preferably, determining the local cost comprises looking up the stored value of the local cost. However if the local cost is not available, then alternatively this value is calculated and stored in stage 6. In stage 7, the path cost of element n is updated from at least the path cost of element d and the local cost of element n, although preferably path cost(s) of any other element(s) that contribute to the path cost of element n are also included (for example, other neighbors of element n that have been marked as final). Optionally one or more other attributes of element n and/or element d are also updated, according the specific graph traversing algorithm being employed. In stage 8, the data structure D is updated according to the new cost from elements n of element d (e.g. —by using the path cost). If however, the element n is not in D, then this element must be added to the data structure D.

In stage 9, once all elements of the data structure D have been considered or a goal has been reached (or other stopping criterion is set to true), then the result of the algorithm is provided. Non-limiting examples of a goal and/or other stopping criterion include reaching a goal, determining a path, marking a plurality of elements and analyzing a moving interface, completely traversing the graph, reaching a maximal allowed path cost, traversing a pre-defined number of elements or a combination thereof.

As a non-limiting example of the result, such a result may comprise the path cost of the last node in the data structure D, the overall path traversed and/or the set of all elements reached. For determining the overall path traversed, typically an additional post-processing step is required for any graph traversal method, as also for the method of FIG. 2, to derive the best path from the collection of elements and their associated path costs. A non-limiting example of such a post-processing step is gradient descent. Indeed any result which may optionally be provided with regard to background art methods, such as that described in FIG. 1, may also be provided by the method of FIG. 2.

FIG. 2B shows an exemplary, non-limiting method for a second process for this exemplary, illustrative non-limiting method for an improved graph traversing algorithm according to at least some embodiments of the present invention. As shown, in stage 1, a data structure associated with the second process is initialized with an initial set of elements and their neighbors, as stated in stage 2 of FIG. 2A above (optionally one or more criteria for such a list of elements for the initialization process are related to stage 5 of FIG. 2A). Optionally, each second process may optionally have its own data structure, or they can share a single data structure. If each second process has its own data structure, then preferably the first process adds elements to these data structures according to some criterion; as a non-limiting example, such addition of one or more elements may optionally be made sequentially to each data structure.

Optionally, the initialization process in stage 1 is initiated according to one or more criteria for placing elements in the data structure. Preferably, the data structure associated with the second process is initialized by the first process.

While the data structure is not empty or some other stopping criterion is not reached, stages 2-6 are performed. Optionally for example, stages 2-6 are performed once some criteria have been reached, such as for example the presence of greater than a certain number of elements e in the data structure, such as 100 for example, although any other constant may also optionally be used. In stage 2, the first element e is retrieved from the data structure. In stage 3 the process checks whether the local cost for element e is stored; if so, then the process proceeds to stage 6. In stage 4, if the local cost is not stored, then it is calculated for element e. In stage 5, the local cost is stored. Once the local cost is stored, in stage 6 optionally the element e is removed from the data structure if each thread has a separate data structure. If a plurality of threads share a data structure, then the element e is removed in stage 2, after retrieval.

One non-limiting example of a stopping criterion is the presence of fewer than a certain number of elements e in the data structure, such as 100 for example, although any other constant may also optionally be used.

In stage 7, the data structure is optionally refreshed according to the results of stage 5 of FIG. 2A, in which the neighbor elements n of element d are optionally and preferably added to the data structure associated with the second process by the first process. Optionally, elements e present in the data structure may be flushed at this time by the second process to enable the neighbor elements n to be added.

The method of FIG. 2B may optionally be performed on a plurality of computational resources in parallel. For example, optionally one or more instances of the second process described with regard to FIG. 2B may optionally be performed on a plurality of computational resources in parallel.

To avoid race conditions between the first process and the one or more second processes, optionally and preferably the value of the local cost is initialized with a special value that cannot appear as a result of the local cost computation (for example: #QNAN (quiet NAN) if the local cost is a floating-point number, or a negative value if the local cost is a nonnegative integer, as neither of these values could arise as a result of the calculation of the local cost).

Writing the value of the local cost is preferably determined so that the first process cannot accept partially written results. This can be achieved by writing the result in an atomic manner, or by ensuring that the test will fail on partially written values.

The calculation of the local cost is preferably re-entrant, such that two processes (such as the first process and the second process, and/or two second processes) can calculate the local cost concurrently without affecting the final result. For example, partial results calculated by the local cost function may optionally be stored at a temporary, process specific location, such that each process has access to its own partial results.

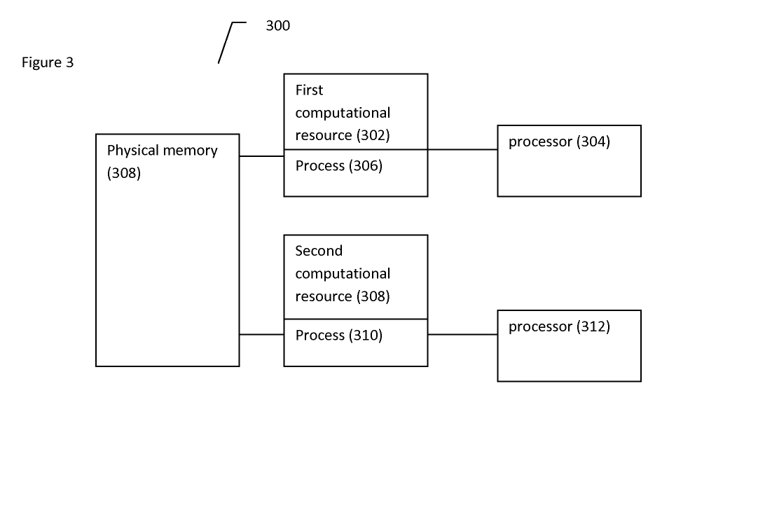

FIG. 3 shows an exemplary, illustrative non-limiting system according to some embodiments of the present invention for traversing a graph, for example for image processing, in which the graph comprises a plurality of portions, each portion comprising a plurality of elements. As shown, a system 300 features a plurality of computational resources shown as a first computational resource 302 and a second computational resource 308. For the purpose of discussion only and without wishing to be limiting in any way, first and second computational resources 302 and 308 are shown as being operated by a processor 304 and a processor 312, respectively, although first and second computational resources 302 and 308 are not necessarily tied to any specific processors (as for virtualization for example) and also each processor 304 and/or 312 may optionally operate a plurality of computational resources (not shown). First computational resource 302 is shown as operating a first process 306, while second computational resource 308 is shown as operating a second process 310, each of which may optionally be one of a plurality of first processes or second process(es). Each processor 304 and 312, and hence each process 306 and 310, has access to a physical memory 308 (shown as being shared by processors 304 and 312, and processes 306 and 310), so that each process 306 and 310 may optionally store and retrieve information in physical memory 308, subject to the previously described rules.

Preferably, second computational resource 308 performs local cost calculations, more preferably in the background, for a plurality of elements of a portion of the graph, including at least a first element d and at least distance x neighboring element(s) m of said first element, in which for this non-limiting example x is any integer greater than one; and first computational resource 302 traverses the portion of the graph at least partially according to the local cost calculations but also preferably according to one or more path costs to analyze the data, which as previously described may be image data. Preferably the first and second computational resources 302 and 308 operate until some type of endpoint is reached as described previously.

Optionally, the second computational resource 308 at least partially determines which local costs to calculate, although alternatively or additionally, the first computational resource 302 may determine which local costs to calculate and may then instruct the second computational resource 308 accordingly. A combination of these approaches is also possible.

Optionally, second computational resource 308 performs calculations in association with a data structure, which for example may optionally be a data structure or any suitable data structure, such that computational resource 308 may optionally continue its calculations as long as the data structure is not empty or a second computational resource stopping criterion is not fulfilled, wherein optionally, as previously described, the second computational resource stopping criterion is independent of graph traversal by the first computational resource 302.

Also optionally second computational resource 308 performs calculations in association with a plurality of data structures, which for example may optionally be a queue or any suitable data structure, and process 310 comprises a plurality of second processes, such that each second process 310 is associated with a separate data structure. Alternatively, a plurality of processes 310 may share a single data structure. Similar configurations may be made for first computational resource 302, one or more processes 306 and any associated data structure(s).

Various configurations of first and second computational resources 302 and 308 are encompassed within at least some embodiments of the present invention. As a non-limiting example, if a plurality of related portions of a graph are to be traversed (for example related portions of an image), a plurality of first computational resources 302 may perform the traversal and share a second computational resource 308.

As a non-limiting example, the image data may optionally comprise medical image data which may for example comprise a blood vessel. Determining the location and path of such blood vessels is a difficult but important problem to solve for image processing of medical image data. For such a problem, the medical image data would first need to be mapped onto an undirected graph as is known in the art. The graph could then be traversed to segment the blood vessel as depicted by the image data. The medical image data may optionally comprise computed tomography (CT) scan data, PET (positron emission tomography) scan data, magnetic resonance (MR) data, and/or any other medical image data.

Next, first computational resource 302 would traverse the graph, including local cost calculations from second computational resource 308. Such traversal may optionally include tracing a plurality of paths representing a plurality of blood vessels. Such traversal is preferably performed as described above and also with regard to FIG. 2. Optionally, each path could be traced as described with regard to US Published Application No. US20100296709A1, “METHOD AND SYSTEM FOR BLOOD VESSEL SEGMENTATION AND CLASSIFICATION”, to OSTROVSKY-BERMAN, Yaron et al, published on Nov. 25, 2010, hereby incorporated by reference as if fully set forth herein.

According to at least some embodiments and without wishing to be limited by a closed list, the method of graph traversal as described herein preferably is able to be performed through parallelization (ie—computing with a plurality of computational resources in parallel) of the search for elements of the graph which will probably be needed soon by the traversal algorithm. This approach both supports parallelization, which cannot be performed if only the local costs that are needed are calculated, yet does not use excessive amounts of computational resources for calculations or storage that are not likely to be necessary for graph traversal.

While the invention has been described with respect to a limited number of embodiments, it will be appreciated that many variations, modifications and other applications of the invention may be made.

What is claimed is:

1. A method for efficiently traversing a graph having a plurality of elements, the method being performed by a plurality of computational resources, the method comprising:
Providing a first computational resource for traversing a portion of the graph, wherein said traversing said portion of said graph comprises calculating a path cost for element d, said path cost being computed from at least a local cost for element d;
Providing a second computational resource for computing a plurality of local costs for a plurality of elements of said portion of the graph;
initiating traversal of said portion of the graph by a first computational resource;
computing said plurality of local costs by said second computational resource;
storing said plurality of local costs to form stored local costs by said second computational resource;
if available, retrieving said local cost associated with said element d of said portion in said stored local costs by said first computational resource;
if said local cost associated with said element d of said portion is not in said stored local costs, calculating said local cost associated with said element d of said portion by said first computational resource; and
traversing said portion of the graph comprising at least said calculating said path cost for element d from at least said local cost for element d by said first computational resource;
wherein said computing, said storing and said retrieving said plurality of local costs are performed more than once.

2. The method of claim 1, further comprising initiating computing of said plurality of said local costs by said second computational resource according to a command from said first computational resource.

3. The method of claim 1, wherein said second computational resource at least partially determines which local costs to calculate.

4. The method of claim 1, further comprising determining which local costs for said second computational resource to compute by said first computational resource; and
instructing said second computational resource by said first computational resource to compute said local costs.

5. The method of claim 1, wherein said initiating said traversal, or said traversal, and said computing said plurality of local costs are performed in any order.

6. The method of claim 1, wherein said traversing said traversed portion of the graph is performed according to one of the fast marching algorithm, A*, Dijkstra's algorithm, the breadth first search algorithm (BFS), the depth first search algorithm (DFS), Uniform Cost Search (UCS) and the targeted fast marching algorithm.

7. The method of claim 1, wherein each computational resource comprises a separate computer, a separate thread of a multithreaded processor, a separate VM (virtual machine) or a separate hardware processor, a plurality of any of the above, or a combination thereof.

8. The method of claim 1, wherein said computing and said storing are performed according to one or more criterion selected from the group consisting of urgency or whether an element has at least a threshold probability to be required for said traversing.

9. The method of claim 8, wherein said urgency is determined according to the relative order in which a local cost will be needed and/or according to computational intensiveness of a particular local cost.

10. The method of claim 1, wherein said computing and said storing are performed in parallel to said traversing said portion of said graph.

11. The method of claim 1, wherein said portion of the graph comprises a plurality of neighboring elements n to element d, and wherein said computing and said storing of said local costs are performed for said neighboring elements n of at least distance x, wherein x is an integer of at least one.

12. The method of claim 11, wherein said first computational resource employs a data structure for graph traversal and wherein after said element d is removed from said data structure, said calculating and said storing of said local costs by said second computational resource are performed for said neighboring elements n of at least distance x, wherein x is an integer of at least two, according to a command from said first computational resource.

13. The method of claim 1, wherein at least said computing, said storing and said traversing are repeated until an endpoint is reached.

14. The method of claim 13, wherein said endpoint is selected from the group consisting of reaching a goal, determining a path, marking a plurality of elements and analyzing a moving interface, completely traversing the graph, reaching a maximal allowed path cost, traversing a pre-defined number of elements or a combination thereof.

15. The method of claim 13, wherein said calculating by said second computational resource is associated with a data structure, said calculating by said computational resource continuing as long as said data structure is not empty or a second computational resource stopping criterion is not fulfilled.

16. The method of claim 1, wherein said calculating by said second computational resource is associated with a plurality of data structures and wherein said second computational resource comprises a plurality of second processes, such that said computing said plurality of local costs is performed by a plurality of second processes, each second process being associated with a separate data structure.

17. The method of claim 1, wherein a first computational resource comprises a plurality of first processes, wherein one or more of said first processes shares one or more second processes.

18. The method of claim 1, wherein said calculating by said second computational resource is associated with a data structure, wherein said second computational resource comprises a plurality of second processes, such that said computing said plurality of local costs is performed by said plurality of second processes, said plurality of second processes sharing said data structure.

19. The method of claim 1, further comprising starting said traversing of said portion of the graph according to a seed of the graph.

20. The method of claim 19, wherein a plurality of portions of said graph are traversed according to a plurality of seeds.

21. The method of claim 1, wherein the graph is related to an image, such that analyzing said image is performed by traversing at least said portion of the graph.

22. The method of claim 21, wherein said image comprises a medical image comprising a blood vessel and wherein said traversing said portion of the graph comprises tracking said blood vessel within said image.

23. A system for processing an image, comprising: an input interface for receiving image data; a digitizer for digitizing said image data to form a graph comprising a plurality of portions, each portion comprising a plurality of elements; a first computational resource for traversing a portion of the graph, wherein traversing said portion of said graph comprises calculating a path cost for element d of said plurality of elements, said path cost being computed from at least a local cost for element d, and wherein said traversing results in analyzed image data; a second computational resource for computing a plurality of local costs for a plurality of elements of said portion of the graph, including at least said local cost for element d; and an output interface for outputting said analyzed image data.
